(19) United States
(12) Patent Application Publication
(10) Pub. No.: US 2023/0167920 A1
(43) Pub. Date: Jun. 1, 2023

(54) VALVE FOR A SPRAY SYSTEM

(71) Applicant: VALEO SYSTEMES D'ESSUYAGE, La Verriere (FR)

(72) Inventors: Maxime BAUDOUIN, La Verriere (FR); Theophile JULLIEN, La Verriere (FR)

(73) Assignee: VALEO SYSTEMES D'ESSUYAGE, La Verriere (FR)

(21) Appl. No.: 17/801,863

(22) PCT Filed: Jan. 19, 2021
(86) PCT No.: PCT/EP2021/050999

§ 371 Date: Aug. 24, 2022

(30) Foreign Application Priority Data
Feb. 28, 2020 (FR) FR2002040

(51) Int. Cl. F16K 39/02; F16K 27/02; B60S 1/48

(52) U.S. Cl. CPC F16K 39/022; F16K 27/02; B60S 1/481

(57) ABSTRACT

The present invention relates to a valve for a spray system for spraying a washing liquid comprising a valve body, enclosing a hydraulic cavity which is configured to be fluidically connected to a hydraulic conduit of the spray system and is intended to receive the washing liquid, a mobile element which is configured to be moved in the hydraulic cavity between an open position, in which it lets the washing liquid pass into the hydraulic conduit, and a closed position, in which it blocks the passage of the washing liquid into the hydraulic conduit, characterized in that the valve also comprises at least one opening provided in the wall, said opening being closed by an elastic membrane which is configured to be deformed if the washing liquid freezes in the hydraulic cavity.

### CROSS-REFERENCE TO RELATED APPLICATIONS

This application is filed under 35 U.S.C. § 371 U.S. National Phase of International Application No. PCT/EP2021/050999 filed Jan. 19, 2021 (published as WO2021170312), which claims priority benefit to French Application No. 2002040 filed on Feb. 28, 2020, the disclosures of which are herein incorporated by reference in their entirety.

### TECHNICAL FIELD

The present invention relates to the field of systems for spraying cleaning liquid for motor vehicles, and in particular to the valves used in these systems.

### BACKGROUND OF THE INVENTION

Motor vehicles all have a cleaning liquid spraying system for keeping the windscreen of the vehicle clean and allowing the driver to see out optimally. This system may also be used for optical devices such as sensors.

These systems generally comprise a tank for cleaning liquid, a pump and at least one valve which is configured to allow or prevent the passage of the cleaning liquid to the various spray endpieces or spray nozzles.

One of the problems with the hydraulic valves placed in the hydraulic circuit of the spray systems is the risk of malfunctioning of the valves, which is linked to the valves becoming frosted. Moreover, in the event of very low temperatures, the cleaning liquid present in the valve can freeze, thereby resulting in damage to the valve due to the water expanding as it freezes, causing the system for spraying cleaning liquid to fail.

### BRIEF SUMMARY OF THE INVENTION

In order to avoid such damage to the valves in the event of freezing, it is therefore necessary to find a solution that makes it possible to protect the electromagnetic valves in the systems for spraying cleaning liquid for motor vehicles in the event of freezing.

To that end, what is proposed is a valve for a spray system for spraying a cleaning liquid, said valve comprising:
a valve body including a hydraulic cavity configured to be fluidically connected to a hydraulic channel of the spray system and intended to receive the cleaning liquid,
a movable element configured to be moved in the hydraulic cavity between an open position in which it allows the cleaning liquid to pass into the hydraulic channel, and a closed position in which it prevents the passage of the cleaning liquid into the hydraulic channel,
at least one opening made in its wall, said opening being closed off by an elastic membrane configured to deform in the event of freezing of the cleaning liquid inside the hydraulic cavity.

According to one embodiment, the movable element is a plunger.

According to one embodiment, the elastic membrane comprises a rigid peripheral portion intended to be secured to the wall of the valve and an elastic central portion configured to deform in the event of freezing of the cleaning liquid.

According to another embodiment, the elastic membrane is made at least partially of elastomer.

According to another embodiment, the elastic membrane is a metal cap.

According to another embodiment, the elastic membrane is produced by bi-material injection molding.

According to another embodiment, the elastic membrane is overmolded on the wall.

According to another embodiment, the elastic membrane is adhesively bonded or welded to the wall.

According to another embodiment, the thickness of the elastic membrane is selected as a function of the pressure of the cleaning liquid inside the hydraulic channel, such that the elastic membrane does not deform over the entire range of pressures at which the valve is used.

According to another embodiment, the surface area of the elastic membrane is selected in such a way as to allow, by its deformation, an increase in the volume of the hydraulic cavity corresponding to an additional volume of the hydraulic cavity obtained by the deformation of the elastic membrane when the cleaning liquid freezes, this additional volume corresponding to at least 10% of the volume of the hydraulic cavity when the membrane is not deformed.

### BRIEF DESCRIPTION OF THE DRAWINGS

Further features and advantages of the invention will become more clearly apparent from reading the following description, which is given by way of illustrative and non-limiting example, and from the appended drawings, in which:

FIG. 1 schematically shows a system for spraying cleaning liquid;

FIG. 2 shows a schematic view in section of a solenoid valve according to one embodiment of the present invention;

FIG. 3 shows a schematic view from the side of a solenoid valve according to one embodiment of the present invention;

FIG. 4 shows a schematic view in cross section of the solenoid valve of FIG. 2 in another configuration.

### DETAILED DESCRIPTION OF THE INVENTION

In these figures, elements that are identical bear the same reference signs.

The following embodiments are examples. Although the description refers to one or more embodiments, this does not necessarily mean that each reference relates to the same embodiment, or that the features apply only to one embodiment. Individual features of different embodiments may also be combined or interchanged to provide other embodiments.

The implementations and embodiments of the invention relate to a valve for a system for spraying liquid.

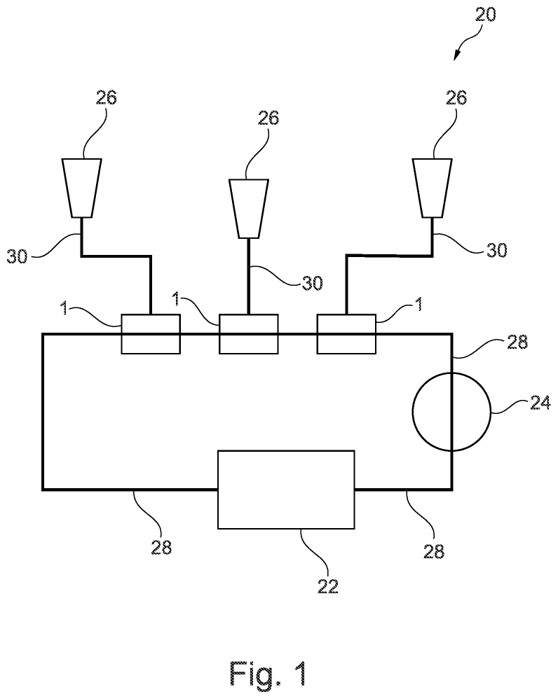

FIG. 1 shows an exemplary embodiment of a spray system 20 comprising a liquid tank 22, a pump 24, and three spray endpieces 26 for spraying cleaning liquid which are configured for example to spray the cleaning liquid over the windscreen or over optical elements of a motor vehicle. The spray system 20 also comprises three valves 1 for controlling the distribution of the cleaning liquid to the spray endpieces 26. The valves 1 are connected to the tank 22 by supply hoses 28 and the spray endpieces 26 are connected to the valves 1 by distribution hoses 30.

The valves 1 are for example electromagnetic valves comprising a coil which, when it is supplied with power, makes it possible to control the movement of a plunger as described in the remainder of the description. However, the invention is not limited to electromagnetic valves and can also be applied to other valve types.

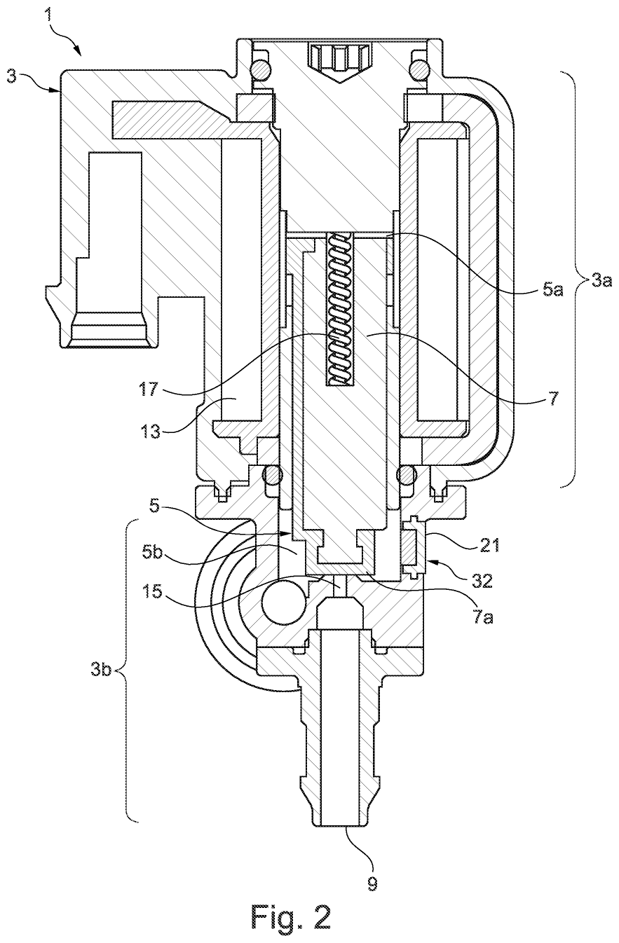

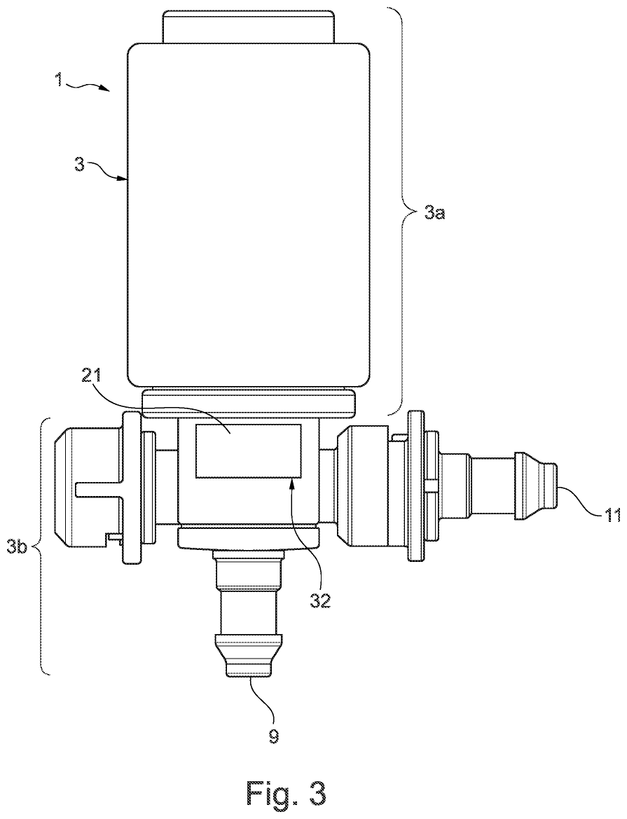

FIG. 2 shows a view in cross section of an electromagnetic valve 1 showing the internal elements of the electromagnetic valve 1, and FIG. 3 shows a view from the side of such an electromagnetic valve 1.

The electromagnetic valve 1 comprises a valve body 3 including a hydraulic cavity 5 in which a movable element in the form of the plunger 7 is positioned. The valve body 3 comprises a first part 3a comprising a coil 13 arranged around a first portion 5a of the hydraulic cavity 5 and a second part 3b in which are formed a first orifice 9, corresponding to an inlet orifice for the fluid, and a second orifice 11 (visible in FIG. 3), corresponding to an outlet orifice for the fluid, and including a second portion 5b of the hydraulic cavity 5.

The first orifice 9 is configured to be attached to a supply hose 28 for the fluid, for example a cleaning or washing liquid. The supply hose 28 is for example connected to a tank 22 for cleaning liquid via a supply pump 24 for supplying the cleaning liquid, as in FIG. 1.

The second orifice 11 is configured to be attached to a spray endpiece 26 via a distribution hose 30.

The electromagnetic valve 1 also comprises a hydraulic channel 15 connecting the first orifice 9 and the second orifice 11, said hydraulic channel 15 being in a fluidic relationship with the hydraulic cavity 5 in which the plunger 7 is disposed (the hydraulic channel 15 therefore locally coincides with the second portion 5b of the hydraulic cavity 5). The hydraulic channel 15 is configured to be continued on either side of the electromagnetic valve 1, in particular via the hoses 28, 30, so as to transfer the cleaning liquid from the tank 22 to a spray endpiece 26.

The plunger 7 is configured to be moved between an open position (not shown), in which it allows the cleaning liquid to pass between the supply hose 28 and the distribution hose 30, and a closed position (shown in FIG. 2), in which it prevents the passage of the cleaning liquid between the supply hose 28 and the distribution hose 30.

The plunger 7 comprises for example a first portion 7a, corresponding to a flexible end in the present case, in particular an elastomer or rubber end, so as to allow good leaktightness in the closed position, the first portion 7a coming into contact with a wall of the valve body 3 in the closed position so as to prevent the passage of the cleaning liquid through the hydraulic channel 15, that is to say between the first orifice 9 and the second orifice 11. The plunger 7 is moved from the closed position to the open position by supplying the coil 13 with power (for example above a predetermined voltage threshold). An elastic retention element 17, for example a helical spring, may be placed between the valve body 3 (or an element which is fixed relative to the valve body 3) and the plunger 7. The elastic retention element 17 is configured to retain the plunger 7 in the closed position when the coil 13 is not supplied with power (or if the power supply is below the predetermined voltage threshold).

Moreover, as shown in FIGS. 2 and 3, to prevent damage to the valve body 3 when the cleaning liquid inside the hydraulic cavity 5 starts to freeze, for example when external temperatures are below 3° C. (this may vary, however, depending on the composition of the cleaning liquid), the electromagnetic valve 1 also comprises at least one opening 32 made in a wall of the valve body 3. Preferably, a single opening 32 is made so as to simplify the manufacture of the valve 1, but it is also possible to make several openings 32. The opening 32 is preferably made in the second portion 5b of the hydraulic cavity 5.

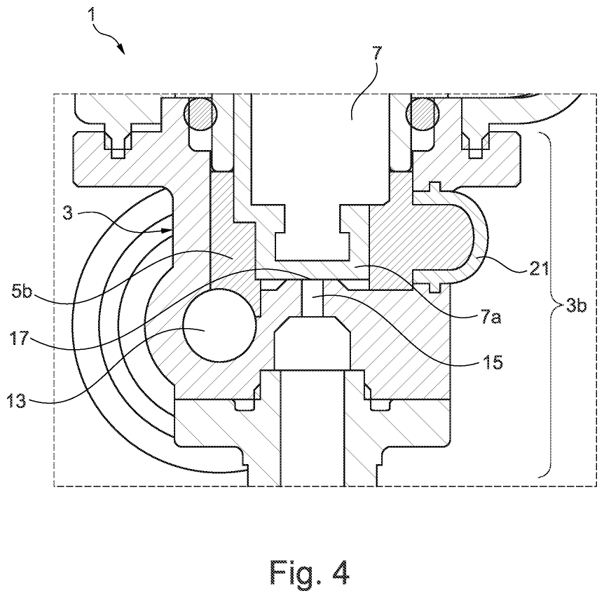

The opening 32 is closed off by an elastic membrane 21 configured to deform in the event of freezing of the cleaning liquid inside the hydraulic cavity 5. FIG. 4 shows the valve 1 when the cleaning liquid is frozen, with the elastic membrane 21 deformed (with respect to its initial shape shown in FIG. 2) as it has expanded due to freezing. The opening 32 has a rectangular shape for example, as shown in FIG. 3, but other shapes are also possible such as a circular shape, for example. The size of the opening 32 may be selected as a function of the volume of the hydraulic cavity 5 in such a way that the elastic membrane 21 is large enough to be able to hold the excess volume in the event of freezing of the cleaning liquid inside the hydraulic cavity 5. The additional volume created by the deformation of the elastic membrane 21 corresponds, for example, to at least 10% of the volume of the hydraulic cavity 5.

The elastic membrane 21 is for example made of plastic, such as a thermoplastic elastomer in particular, but other elastic materials may also be used such as thermosetting elastomers; thermoplastic or thermosetting polymers other than elastomers; or metals or alloys, in particular in the form of a metal cap. To ensure a good seal at the elastic membrane 21, various methods may be used to secure the elastic membrane 21 to the valve body 3. The elastic membrane 21 may be adhesively bonded, welded or overmolded, for example. Bi-material injection molding may also be used to obtain a peripheral part forming a rigid contour configured to be secured to the wall of the valve body 3 and a central part made of flexible, elastic material. The thickness of the elastic membrane 21 may be selected as a function, on the one hand, of the material selected for the membrane and, on the other hand, of the range of pressures at which the valve 1 is used, such that the elastic membrane 21 does not deform during normal use of the valve 1, i.e. when the cleaning liquid is not frozen, or during use within the specified range of pressures (a vent is generally provided in the event of excess pressure occurring in the hydraulic circuit of the spray system 20).

Thus, in operation, when the cleaning liquid inside the hydraulic cavity 5 of the valve 1 freezes owing to very low temperatures, for example below −10° C., the extra volume taken up by the frozen cleaning liquid owing to its expansion exerts a force on the walls of the valve body 3. This force causes the elastic membrane 21 to deform, as shown in FIG. 4. To be specific, as the elastic membrane 21 is less rigid than the other areas of the wall of the valve body 3, it is the elastic membrane 21 that becomes deformed. When the temperature rises again, the frozen cleaning liquid melts and resumes its liquid form. The elastic membrane 21 then returns to its initial shape. The elastic membrane 21 thus makes it possible to prevent any damage to the valve body 3 or to the elements inside the hydraulic cavity such as the plunger 7, in the event of freezing of the cleaning liquid. Moreover, the valve becomes operational once more when the temperature rises, without the need for manual intervention to make it operational.

What is claimed is:

1. Valve for a spray system (20) for spraying a cleaning liquid, said valve comprising:
a valve body including a hydraulic cavity configured to be fluidically connected to a hydraulic channel of the spray system (20) and intended to receive the cleaning liquid,
a movable element configured to be moved in the hydraulic cavity between an open position in which it allows the cleaning liquid to pass into the hydraulic channel, and a closed position in which it prevents the passage of the cleaning liquid into the hydraulic channel,
characterized in that the valve also comprises at least one opening made in its wall, said opening being closed off by an elastic membrane configured to deform in the event of freezing of the cleaning liquid inside the hydraulic cavity.

2. Valve according to claim 1, in which the movable element is a plunger.

3. Valve according to claim 1, in which the elastic membrane comprises a rigid peripheral portion intended to be secured to the wall of the valve and an elastic central portion configured to deform in the event of freezing of the cleaning liquid.

4. Valve according to claim 1, in which the elastic membrane is made at least partially of elastomer.

5. Valve according to claim 1, in which the elastic membrane is a metal cap.

6. Valve according to claim 1, in which the elastic membrane is produced by bi-material injection molding.

7. Valve according to claim 1, in which the elastic membrane is overmolded on the wall.

8. Valve according to claim 1, in which the elastic membrane is adhesively bonded or welded to the wall.

9. Valve according to claim 1, in which the thickness of the elastic membrane is selected as a function of the pressure of the cleaning liquid inside the hydraulic channel, such that the elastic membrane does not deform over the entire range of pressures at which the valve is used.

10. Valve according to claim 1, in which the surface area of the elastic membrane is selected in such a way as to allow, by its deformation, an increase in the volume of the hydraulic cavity corresponding to an additional volume of the hydraulic cavity obtained by the deformation of the elastic membrane when the cleaning liquid freezes, this additional volume corresponding to at least 10% of the volume of the hydraulic cavity.
